(19) United States
(12) Patent Application Publication
(10) Pub. No.: US 2002/0180357 A1
(43) Pub. Date: Dec. 5, 2002

(54) LAMP WITH SHAPE HAVING HIGH DIMENSIONAL ACCURACY

(76) Inventors: HIROMITSU MATSUNO, HIMEJI-SHI (JP); TETSUYA TORIKAI, FUKUOKA-SHI (JP); KENJI MORINAGA, TSUKUSHI-GUN (JP); YUKIHARU TAGAWA, HIMEJI-SHI (JP)

Correspondence Address: SIXBEY FRIEDMAN LEEDOM & FERGUSON PC, 8180 GREENSBORO DRIVE, SUITE 800, MCLEAN, VA, 22102

(21) Appl. No.: 09/375,355

(22) Filed: Aug. 17, 1999

(30) Foreign Application Priority Data
Aug. 17, 1998 (JP) 10-230853

(51) Int. Cl. H01J 17/18; H01J 61/36

(52) U.S. Cl. 313/625

(57) ABSTRACT

A lamp, particularly a discharge lamp, in which an bulb portion of the lamp vessel can be formed with high dimensional accuracy and an advantageous light radiation characteristic and long service life obtained is achieved by the lamp vessel having and its bulb portion and scaling tube portions which are formed from a compacted body of sintered silica glass, and by sealing components, which are hermetically connected to the sealing tube portions and to which an emission part in the bulb is joined, having a first end which is made of silicon dioxide and a second end that is made of a functional gradient material which contains an electrically conductive inorganic material component as the main constituent.

### BACKGROUND OF THE INVENTION

1. Field of the Invention

The invention relates to a lamp with a lamp vessel in which an arc tube portion is located.

2. Description of Related Art

Generally, a lamp is arranged such that, in a hermetically sealed bulb portion of a lamp vessel, there is an emission part with discharge electrodes or filament coils. Fused silica glass has been preferably used for a long time as the material of the lamp vessel. The reason for this lies in the following effects:

(1) Since the linear transmission factor is high, a high degree of light utilization is obtained.

(2) Since the coefficient of thermal expansion is small and the resistance to thermal loading is high, high reliability is obtained.

(3) Due to high hydrogen permeability, the hydrogen which has formed in the bulb portion is released to the outside from the lamp vessel. This yields a long life.

A high pressure mercury lamp with a fused silica glass lamp vessel is described for example in Japanese patent disclosure document HEI 06-052830.

In a conventional general production process, the fused silica glass material of the lamp vessel is produced as follows:

A fused silica glass, rod-shaped initial tube as a manufactured product is heated by a hydrogen-oxygen flame or the like to at least 2000° C. and caused to melt. By using the deformability in this state, for example, an arched bulb portion and a hermetically sealed tube portion which is joined thereto are formed.

It is necessary to arrange in the lamp vessel an emission part, such as discharge electrodes or filament coils, such that its power supply path runs hermetically from the outside to the inside.

To do this the following process is undertaken:

A module is produced in which an outer lead is connected to one end of the emission part via a molybdenum metal foil with a thickness of a few dozen microns. This module is placed in the hermetically sealed tube portion. In this case, the fused silica glass of the hermetically sealed tube portion which is located in the vicinity of the metal foil is heated to at least 2000° C., melted and compressed. In this way, a sealing area is formed in which the fused silica glass is deposited hermetically on both sides of the metal foil.

However, the lamp obtained by the above described process has the following defects:

(1) Based on the process in which the initial tube of fused silica glass is deformed in the molten state, it is very difficult to accurately control the shape of the lamp vessel to be formed.

Since in initial tubes of fused silica glass as manufactured goods the outside diameter, the inside diameter and the thickness do not have constant dimensions from tube to tube or even in the same tube, it is not possible to form a bulb portion with the desired high dimensional accuracy.

Consequently, in the case of a lamp vessel with a small inner volume and in which only a small distance exists between the discharge electrodes, a point source lamp is formed and is used in combination with a focusing optics system as, for example, in the high pressure mercury lamp described in the aforementioned Japanese patent disclosure document, the size of the inner volume of this lamp vessel cannot be controlled. Therefore, the emission characteristic is not constant. Furthermore, the wall thickness of the bulb portion becomes nonuniform, causing a lens effect and distorting the optical path of the radiant light. As a result, the defect of a reduction of the focusing efficiency and similar defects arise.

(2) By heating the fused silica glass to a high temperature of at least 2000° C. and by melting it, the phenomenon occurs that fine particles of SiO₂ and SiO (hereinafter called fine particles of silicon dioxide) form and are deposited on the inside of the bulb portion. These fine particles of silicon dioxide are sprayed after completion of the lamp in the bulb portion, are deposited on the surfaces of the discharge electrodes or the filament coils and react chemically with the material components thereof. Therefore, the discharge electrodes or filament coils are worn away and the lamp life is reduced.

(3) Since a hydrogen-oxygen flame or the like is used to melt the fused silica glass, the phenomenon occurs that water molecules are mixed into the fused silica glass and they are emitted into the bulb portion during the service life of the lamp.

As a result, water molecules are deposited on the discharge electrodes or filament coils and react with them. This wears off the discharge electrodes and filament coils, and shortens the lamp life.

(4) Since the metal foils used are brittle and the molten fused silica glass in the hermetically sealed tube portion is pressed against these metal foils and tightly adjoins the metal foils in the formation of the hermetically sealed areas of the lamp vessel, the metal foils are easily deformed or moved by the flow of the molten fused silica glass. As a result, the positions of the discharge electrodes or filament coils which are connected to the metal foils in the bulb portion of the emission part cannot be controlled with high precision. Consequently, in a discharge lamp, the distance between the electrodes cannot be accurately controlled, by which eccentricity of the discharge electrode occurs. Furthermore, there is the defect that, in the case of use in combination with a focussing optics system, high focusing efficiency cannot be obtained.

### SUMMARY OF THE INVENTION

The invention was devised to eliminate the above described defects in the prior art. Therefore, a primary object of the invention is to devise a lamp in which the bulb portion of the lamp vessel can be formed with high dimensional accuracy, which therefore has a lamp vessel with the desired shape and desired dimension, and with which an advantageous light radiation characteristic and long service life are obtained, and which can be easily produced.

In a lamp in which, in an bulb portion of a lamp vessel, there is an emission part with discharge electrodes or a filament coil, this object is achieved in that the lamp vessel has a bulb portion and sealing tube portions which are formed from a compacted body of sintered silica glass, and furthermore, that the lamp vessel has sealing components which are each hermetically connected to the sealing tube portion and to which the emission part is joined. Additionally, one end of the respective sealing component is made of silicon dioxide and the other end contains an electrically conductive inorganic material component as the main component, the sealing component having functional gradient material in which the concentration of the electrically conductive inorganic material component increases gradually from one end in the direction to the other end.

The object is furthermore achieved in accordance with the invention by the compacted body of sintered silica glass containing an aluminum oxide component at a volumetric percentage from 1 to 10%.

The object is moreover achieved in the lamp according to the invention in that the respective sealing tube portion of the lamp vessel and a side area of one end of the sealing component are interconnected by a frit material with a softening point which is lower than the softening point of the sealing tube portion and the softening point of the side area of one end of the sealing component.

Still further, the object is advantageously achieved in accordance with the invention in that the respective sealing tube portion and the side area of one end of the sealing component are arranged tightly adjoining one another and that the two are interconnected by heating and melting the site at which the two are arranged tightly adjoining one another. In this case, it is preferred that the inner peripheral surface of the sealing tube portion has a tapering shape which opens in the direction to the tip, and that the outer peripheral surface of the side area of one end of the sealing component has a tapering shape which matches the inner peripheral surface of the sealing tube portion.

The object is moreover advantageously achieved as claimed in the invention in that the inside and/or outside of the bulb portion is provided with an UV absorption film.

The object is additionally achieved according to the invention advantageously in that the inside and/or outside of the bulb portion is provided with an IR reflection film.

In the above described lamp the bulb portion and the sealing tube portions connected thereto are each formed from a compacted body of sintered silica glass and the lamp vessel is formed by the sealing component of a functional gradient material being provided with the respective sealing tube portion. By this measure an bulb portion and sealing tube portions with high dimensional accuracy can be achieved and the emission part such as discharge electrodes or filament coils can be arranged in the bulb portion with high positioning accuracy. Thus a lamp can be devised which reliably has the expected output. Furthermore, in this lamp an advantageous light radiation characteristic can be obtained because no fine silicon dioxide particles form.

In the following, the invention is further described using several embodiments shown in the drawings.

### BRIEF DESCRIPTION OF THE DRAWINGS

FIG. 1 is a schematic partial cross section of the arrangement of one example of the discharge lamp in accordance with the invention;

FIG. 2 is a schematic partial cross section of a production process of another embodiment of the discharge lamp according to the invention; and

FIG. 3 is a schematic cross section of a rod-shaped filament lamp in accordance with another embodiment of the invention.

### DETAILED DESCRIPTION OF THE INVENTION

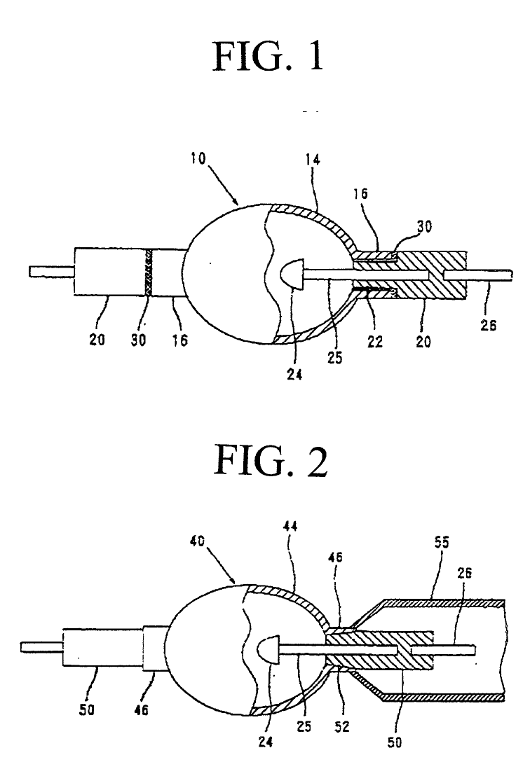

In FIG. 1, an embodiment of a discharge lamp 10 is shown having the lamp vessel comprised of an arc tube portion 14 with a roughly spherical outer shape and rod-shaped sealing tube portions 16 which are formed integrally with the arc tube portion 14 such that they project laterally from opposite ends of the arc tube portion 14. The lamp vessel is formed by a sealing component 20 being hermetically connected to each of the sealing tube portions 16.

The component 20 being formed of the same material as the lamp vessel and of a functional gradient material. In this example, a first end of the sealing component 20 is formed of silicon dioxide, while the area outside this first end is made of a mixture of silicon dioxide and an electrically conductive, inorganic component, for example, molybdenum or the like. The second end of the sealing component 20 contains this electrically conductive inorganic component as its main constituent. The sealing component 20 has an overall cylindrical shape, the concentration of the electrically conductive inorganic material component increases gradually from the first end in the direction toward the second end.

The first end of the sealing component 20 of silicon dioxide has a head portion 22 with a smaller diameter which has an outer diameter which matches the inner diameter and length of the sealing tube portion 16. The remaining area of the sealing component 20 has the same outside diameter as that of the sealing tube portion 16. In the state in which the smaller diameter head portion 22 of the sealing component 20 is installed and inserted in the sealing tube portion 16 formed of the material of the lamp vessel, by means of a frit material 30 which is inserted between the two parts 16, 22, the sealing tube portion 16 and the sealing component 20 are hermetically joined to one another, and thus, a hermetically sealed area is formed.

A discharge electrode 24 which is part of the emission part and which is supported by an upholding part of an electrode 25 which is integrally connected and attached to the sealing component 20 such that it is inserted into an opening which extends from an inner end face of the first end of the sealing component 20. The tip area of this upholding part of electrode 25 extends to a location of the sealing component 20 at which the concentration of the electrically conductive, inorganic material component is high and which, in practice, has electrical conductivity.

On the other hand, the second end of the sealing component 20 is provided with a conductivity and a high concentration of the conductive inorganic material component and with an opening which extends inwardly from the outer end face and into which an end of an outer lead pin 26 is inserted and attached. In this way, the upholding part of electrode 25 and the outer lead pin 26 are electrically connected to one another via the conductive areas of the sealing component 20.

The arc tube portion 14 together with the sealing components 20 forms a closed discharge space in which the discharge electrodes 24 are positioned and the required discharge gas is added. The light produced by the emission part is, for the most part, emitted to the outside via the wall of this arc tube portion 14.

The arc tube portion 14 and the sealing tube portions 16 joined integrally therewith are made of a compacted translucent body of sintered fused silica glass which is obtained as follows:

A pulverized compacted body is formed as the primary compacted body from powder with silica glass (silicon dioxide) as the main component, and it is sintered such that it is heated to the sintering temperature which is lower than the melting point (1720° C.) of the fused silica glass.

A compacted body of sintered silica glass is essentially described in the “Journal of the Ceramic Society of Japan” 105 (2), p. 171 to 174 (1997). However, specifically it can be produced as follows.

Raw powder with silica glass as the main component is prepared. It is preferred that the silica glass proportion in this raw powder is at least 90 percent by volume. It is especially preferred that the proportion is greater at least equal to 95 percent by volume.

The average grain size of the raw silica glass powder is not specially fixed. It is usually preferred that it is 0.1 to 10 microns, and especially 0.5 to 5.0 microns. It is difficult to treat powder with an extremely small average grain size. On the other hand, when using powder with an unduly large average grain size, there is the danger that the translucence of the resulting compacted body of sintered silica glass will become low.

The process for producing the pulverized compacted body is not especially limited, it being possible to use various different conventional processes. In the case of a casting process, which is the most common process, for example, raw powder is mixed with a binder and water to produce a suspension. This suspension is injected and dried in a separately produced gypsum mold with a shape which corresponds to the outside shapes of the arc tube portion and sealing tube portions. Thus, a pulverized compacted body with the expected thickness is obtained. The thickness of the compacted silica glass body which is ultimately obtained can be adjusted by controlling the amount of applied mass on the inside of the gypsum mold.

The binder can be, for example, higher fatty acids, such as stearic acid or the like, metal salts of higher fatty acids, such as zinc stearate or the like, a hydrophilic macromolecular material, such as polyvinyl pyrrolidone or the like, or something else.

Furthermore, in addition to the aforementioned casting process the following process can be used:

A soft, plastic molding material is prepared which contains a binder and water. Using this material, a rod-shaped tube is produced by extrusion molding and is blown into a spherical shape by blow molding. In this way, an arc tube portion and sealing tube portions connected thereto are formed.

In addition, a pulverized compacted body can be produced by a “rubber-pad press” process in which the same mold material as in the above described example is placed in a rubber mold and hydrostatic pressure is used.

The pulverized compacted body which has been produced in the manner described above is dried if necessary or temporarily sintered by heating to 500 to 1200° C. This yields a pulverized compacted body or a temporarily sintered body with the binder and water removed. Sintering this body yields the sintered silica glass compacted body to be obtained.

Sintering of the pulverized compacted body can be performed by heating in a vacuum to a temperature of at least 1450° C. but which is lower than the melting point of the fused silica glass. However, it is preferred that the maximum sintering temperature be 1600 to 1700° C.

The rate of temperature rise to reach the maximum sintering temperature is not specially fixed. However, it is usually 5 to 50° C./min, preferably 10 to 300° C./min, and especially 15 to 20° C./min.

In sintering, it is not essential to maintain the state heated to the above described maximum sintering temperature. When the pulverized compacted body reaches this maximum sintering temperature, the temperature can be lowered directly thereafter.

In the case of a maximum sintering temperature of less than 1450° C., the resulting compacted body of sintered silica glass is opaque, and the translucency is extremely low, even if the average grain size of the raw powder is small.

On the other hand, the pulverized compacted body is melted and deformed when it is heated to a temperature greater than or equal to the melting point of the fused silica glass. In doing so, a useful material for the lamp vessel cannot be obtained.

In the case of the maximum sintering temperature from 1600 to 1700° C., the advantage is that, regardless of the average grain size of the raw powder of silica glass, the compacted body of sintered silica glass obtained has a high degree of translucency. Especially at 1650 to 1700° C., an advantageous compacted body of sintered silica glass can be reliably obtained without keeping the sintered body at the maximum sintering temperature.

In the case of a maximum sintering temperature from 1450 to 1600° C., the maximum sintering temperature must be preserved for a certain time when the average grain size of the raw powder is large, i.e., for example, when it is at least 2.0 microns. If this holding time is short, there is the danger that the resulting compacted body of sintered silica glass will have a low transparency and low translucency. Sintering treatment therefore takes considerable time.

The silica glass compacted body obtained by the above described sintering treatment shrinks compared to the pulverized compacted body as the primary compacted body. However, the amount of shrinkage is only low. Since no deformation by melting occurs, the resulting compacted body of sintered silica glass has essentially the same or similar form as the pulverized compacted body and is therefore identical in form. The amount of shrinkage in the pulverized compacted body is usually, in practice, less than or equal to roughly 10 to 20%.

If using a suitable mold to produce the compacted body, for example, a gypsum mold or the like, a pulverized compacted body is produced; therefore, a pulverized compacted body is obtained with a shape which corresponds to this gypsum mold. As a result, a compacted sintered silica glass body is obtained with a shape which corresponds to this pulverized body. Consequently, a compacted sintered silica glass body can be obtained with a shape which is very similar to this gypsum mold, and furthermore, with high dimensional accuracy and high precision of shape.

Since, in this sintered silica glass compacted body, it is enough if the silica glass used as the raw material is heated to a temperature which is lower than its melting point, production is extremely simple. Furthermore, formation of fine particles of silicon dioxide, as occurs when heating to a high temperature, is prevented. As a result, by using this compacted body of sintered silica glass for the material of the lamp vessel, a lamp with stable performance, high reliability and long service life can be obtained.

If necessary, also raw powder of silica glass can be used which contains a powder of another metal oxide to obtain the above described compacted body of sintered silica glass.

For example, raw silica glass powder can be used which contains aluminum oxide powder. In this case, a pulverized compacted body with a good ability to retain its shape, i.e, with a good property of preserving its inherent shape, is obtained. Therefore, deformation or breakdown of the pulverized compacted body during sinter treatment is effectively prevented. As a result, a sintered silica glass compacted body with high dimensional accuracy can be reliably obtained even if it has a complex shape. Furthermore, it has high thermal resistance. Here, it is preferred that the content of aluminum oxide powder in the raw powder is at a volumetric ratio from 0.5 to 10%, especially a volumetric ratio from 1 to 5%.

Besides aluminum oxide, as the metal oxide, an oxide of a transition metal, such as titanium oxide (TiO₂), cerium oxide (CeO₂), neodymium oxide (Nd₂O₃), iron sesquioxide (Fe₂O₃) or the like or something else can be added to the raw powder. Mixtures of oxides can also be used.

For example, if titanium oxide or cerium oxide powder is included, a compacted body of sintered silica glass is obtained which has the property of so-called ozone-free fused silica glass that partially prevents transmission of UV radiation. Therefore, it is useful as a material for the lamp vessel in a certain discharge lamp.

When neodymium is used, a compacted body of sintered silica glass is obtained with the optical property that yellow light is shielded. In this way, a lamp with improved chroma of the radiant light is obtained.

It is preferred that the powders of these added components are contained in a proportion no greater than 500 ppm relative to the raw powder.

It is preferred in sinter treatment that the maximum sintering temperature be fixed in a certain range, as was described above. Furthermore, if the atmosphere for the sinter treatment is controlled, a compacted body of sintered silica glass with an advantageous property as the material for the lamp vessel is obtained.

In the discharge lamp 10 in the example shown in the drawing, the lamp vessel is formed from the arc tube portion 14 and the sealing tube portions 16 which are made of the above described compacted body of sintered silica glass and are made integral with one another, and the sealing components 20. The respective sealing component 20 has a first end made of silicon dioxide and a second end with a main component which is a conductive inorganic material, such as molybdenum or the like. The sealing component 20 is made of a functional gradient material in which the concentration of this conductive inorganic material increases gradually from the first end in a direction toward the second end. Here, a lateral area of the first end of the sealing component 20 is installed in the sealing tube portion 16 and is connected to the sealing tube portion 16 by a frit material 30 that has a softening point which is lower than the softening point of the compacted silica glass body which forms the arc tube portion 14 and the softening point of the lateral area of one end of the sealing component 20.

Therefore, sealing areas are formed without melting of the sealing tube portions 16. Thus, the sealing components 20 can be attached in the sealing tube portions 16 which are made integrally with the arc tube portion 14 with high dimensional accuracy. Furthermore, the sealing components 20 can also be formed with high dimensional accuracy. As a result, the emission part which is held and attached in the sealing components 20, specifically, the discharge electrodes 24, can be arranged in the arc tube portion 14 with extremely high dimensional accuracy. Accordingly, sealing areas can be produced which are far stronger than the sealing areas using conventional metal foils. Thus, a lamp with stable performance and high reliability can be produced.

In particular, by using a frit material 30 with a low softening point for connection, there is no danger of deformation of the arc tube portion 14, the sealing tube portions 16 and the sealing components 20. As a result, high dimensional accuracy is maintained by the compacted body of sintered silica glass. Furthermore, the temperature necessary for connection is low, which also prevents fine silicon dioxide particles from the fused silica glass from forming.

FIG. 2 shows a schematic cross section of a production process of another embodiment of the discharge lamp in accordance with the invention.

In the embodiment of FIG. 2, the discharge lamp 40 has a lamp vessel with a spherical arc tube portion 44 and sealing tube portions 46 which are made integrally with the arc tube portion 44. The lamp vessel is closed by sealing components 50 of a functional gradient material being hermetically joined to the sealing tube portions 46. The arc tube portion 44 and the sealing tube portions 46 are formed from a compacted body of sintered silica glass which is produced in the above described manner.

The inner peripheral surface of the sealing tube portion 46 has a tapered shape in which the inner diameter increases incrementally in a direction toward the outer end. A head 52 with the shape of a truncated cone with a tapered shape is formed on the silicon dioxide end of the sealing component 50 which matches the inner peripheral surface of the sealing tube portion 46 in the area connected thereto. The head 52 is inserted in this sealing tube portion 46 tightly adjoining it. In this state, the tightly adjoining surfaces are melted by heating, hermetically sealed, and thus, a sealing area is formed.

The sealing component 50 is made of the same functional gradient material as the sealing component 20 in the example shown in FIG. 1. In this sealing component 50, the upholding part of the electrode 25 which supports the discharge electrode 24 is attached. Furthermore, the outer lead pin 26 is attached in the sealing component 50. In this way, a sealing part arrangement is obtained as was the case also in the embodiment as shown in FIG. 1.

In FIG. 2, an outlet tube 55 with a large diameter is connected to the end of the sealing tube portion 46. After completion of hermetic sealing of one of the sealing tube portions 46 (here, the left sealing tube portion), the arc tube portion 44 is evacuated by this outlet tube 55, and afterwards, the required emission gas or the like is added. In this state, the sealing component 50 is inserted in the other sealing tube portion 46, here the right one, and arranged to be tightly adjoining, and a sealing area is formed by a melt connection. Afterwards, the outlet tube 55 is removed from the site at which it is connected to the sealing tube portion 46 by cutting and a complete discharge lamp 40 is obtained.

In the above described arrangement, the sealing area is formed by a melt connection of the surfaces of the sealing tube portion 46 and the head 52 of the sealing component 50 which tightly adjoin one another. Since both the sealing tube portion 46 and also the sealing component 50 can be easily formed with high dimensional accuracy, the tightly adjoining surfaces with a size necessary to form the sealing area are easily guaranteed, as was described above. Furthermore, the molten sites need be only these tightly adjoining surfaces. Therefore, the two can be easily hermetically joined to one another by short processing in which these tightly adjoining surfaces are intensively heated and the sealing tube portion 46 and the head 52 are not subject to deformation, and thus, preserve their own shapes.

It is a good idea if the length of the above described tightly adjoining surfaces which are subject to melt joining is at least roughly 2 mm.

In a lamp with this arrangement only the tightly adjoining surfaces of the sealing tube portion 46 and the head 52 of the sealing component 50 are heated to form the sealing area. The shape of the materials of the lamp vessel is therefore preserved unchanged. Since the processing time by heating is also short, no fine silicon dioxide particles form. Therefore, a lamp is obtained with advantageous performance, high reliability and long life.

Furthermore, as in the example shown in the drawings, tightly adjoining surfaces with the required length are easily guaranteed since they have a tapered shape. In addition, a tightly adjoining state can be adequately obtained, for example, by pressing in the sealing component 50 in the axial direction. This simplifies production greatly in practice.

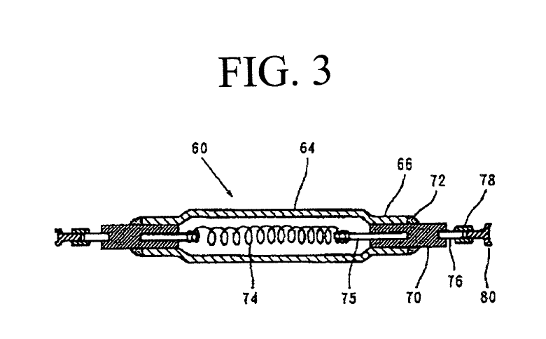

FIG. 3 is a schematic cross section of a rod-shaped filament lamp of another embodiment of the invention. In FIG. 3, a filament lamp 60 in this example has a lamp vessel which comprises a rod-shaped bulb portion 64 and sealing tube portions 66 which are made integral with the bulb portion 64. Sealing components 70 of a functional gradient material are hermetically joined to the sealing tube portions 66. In this way, the lamp vessel is produced. The bulb portion 64 and the sealing tube portions 66 are formed by the compacted body of sintered silica glass which was produced in the above described manner.

The cylindrical sealing component of a functional gradient material, at its silicon dioxide end, is provided with an outside diameter which is matched to the inside diameter of the sealing tube portion 66 and is inserted into the rod-shaped sealing tube portion 66. In this state, the outside face of the sealing tube portion 66 is provided with a frit 72. By means of a hermetic connection of the sealing tube portion 66 and of the sealing component 70, a sealing area is formed.

The sealing component 70 is formed of the same functional gradient material as the sealing component 20 in the FIG. 1 embodiment. On the inside face of this sealing component 70, an inner lead pin 75 is attached which supports a filament coil 74 which forms the emission part. An outer lead pin 76 projects from the outer face of the sealing component 70. A metal contact 80 is coupled to the tip of the outer lead pin 76 via a cylindrical coupling component 78.

In a filament lamp 60 with this arrangement, the bulb portion 64 and the sealing tube portions 66 are formed from a compacted body of sintered silica glass. Its dimensional accuracy is therefore high. The filament coil 74 is therefore easily and exactly placed in a desired position so that it extends, for example, along the axis of the bulb portion 64. Therefore, this filament lamp 60 can reliably have the expected performance. Furthermore, by forming the bulb portion 64 and the like from a compacted body of sintered fused silica glass, adverse effects from impurities, which as fine silicon dioxide particles and the like, are prevented. Thus, a filament lamp with an advantageous light radiation characteristic and long life can be obtained.

A UV absorption film can be formed on at least one of the inside and outside of the bulb portion of the lamp vessel. In this way, a lamp is obtained which does not emit UV radiation which is harmful to the human body, although the lamp has a fused silica glass bulb portion.

This UV absorption film can be produced, for example, by depositing and melting a layer of titanium oxide powder. However, it is especially preferred that the material which forms the UV reflection film be deposited on the surface of the area which forms the bulb portion in a temporarily sintered body which is used for obtaining a compacted body of sintered silica glass. In this method, in sinter treatment of the temporarily sintered body the above described material is melted. In this way, a UV absorption film can be formed without special heating separately. Furthermore, the formed UV absorption film is securely deposited on the compacted body of sintered fused silica glass because the temporarily sintered body has a porous state.

In the lamp according to the invention, an IR reflection film can also be formed on at least one of the inside and outside of the bulb portion of the lamp vessel. By means of this arrangement, the IR radiation emitted from the emission part of the lamp is not emitted to the outside, but is returned to the bulb portion. This prevents the temperature of the emission part from dropping. The lamp thus acquires high radiant efficiency.

In the following, the invention is described using several embodiments. However, the invention is not limited to these embodiments.

(Embodiment 1)

In this embodiment a discharge lamp with the arrangement shown in FIG. 1 is produced.

(Production of a Pulverized Compacted Body)

A pulverized compacted body was produced in the manner described below by a casting process.

By mixing 100 g of silica glass powder with an average grain size of 1.5 microns, 20 g pure water and 2 g of binder, a suspension was produced.

This suspension was poured into a separately produced gypsum mold, applied to the inside of the mold and dried; its inside corresponds to the outside shapes of the arc tube portion and the sealing tube portions of the lamp vessel. Thus, a pulverized compacted body as the primary compacted body is obtained with a shape which is similar to the outside shape of the lamp vessel. The thickness of this pulverized compacted body was 3.4 mm.

The above described pulverized compacted body was heated for about one hour in a hydrogen atmosphere at 1000° C. In this way, a temporarily sintered body was obtained which is in a state in which the silica glass powder is loosely bound. The linear transmission factor of the radiation is very low and is, for example, at most 1%.

(Production of the Material for the Lamp Vessel)

The above described temporarily sintered body was heated in an atmosphere with a negative pressure of 10⁻⁴ Pa to 1650° C. In this way, sinter treatment was performed. Thus, a material for the lamp vessel was produced from the compacted body of sintered silica glass. This material of the lamp vessel had the same translucency as conventional fused silica glass.

(Production of the Sealing Components)

On the other hand, sealing components of a functional gradient material were produced as follows:

Silicon dioxide powder and molybdenum powder are prepared. By mixing the two powders with different proportions, ten different mixed powders with different molybdenum proportions were produced with which a cylindrical casting mold was filled layer by layer in the sequence of the larger molybdenum portion to the smaller until it was finally filled only with the silicon dioxide power and was heated. In this way, a compressed layered structure with a total of eleven layers was produced. It was heated for about one hour in a hydrogen atmosphere at 1200° C. This yielded a temporarily sintered body which was provided with an opening into which the upholding part of an electrode and the outer lead pin are inserted. Furthermore, the temporarily sintered body was machined by cutting, one head part having been formed with a smaller diameter which matches the sealing tube portion as the material of the lamp vessel.

In the state in which the upholding part of an electrode with a tip provided with a discharge electrode and the outer lead pin are inserted into the respective opening of the processed piece obtained in this way, sintering was performed in a vacuum atmosphere at a temperature of 1800° C. In this way, a sealing part arrangement was produced in which the upholding part of the discharge electrodes and the outer lead pins are coupled in one piece to the sealing components. Here, the sealing components are made of a functional gradient material in which a first end is made of layers of only silicon dioxide and the second end of layers with a molybdenum proportion of 72% by weight, and in which, furthermore, the concentration of the molybdenum component decreases from the second end in the direction toward the first end gradually and incrementally.

The sealing part arrangement has the following dimensions:

Total length of the sealing component: 12 mm

Outside diameter of the sealing component: 2.8 mm

Outside diameter of the head part with a smaller diameter: 3 mm

Length of the head part with a smaller diameter: 17 mm

Diameter of the upholding part of an electrode: 0.6 mm

Diameter of the outer lead pin: 0.6 mm

(Production of the Lamp)

In one of the sealing tube portions formed of the material for the lamp vessel there were arranged the sealing part arrangement and a frit. This frit contains silicon dioxide (SiO₂), zinc oxide (ZnO) and boron oxide (B₂O₃) with a molar ratio of 96:2.4:1.6. This assembly was located in an oven. The frit was heated to 1700° C. and melted under a vacuum. In this way, the sealing part arrangement was hermetically joined to the sealing tube portion.

Next, the arc tube portion was filled with mercury in the amount of 0.22 mg/mm³ as well as 3×10⁴ micromole/mm³ bromine and 10 kPa argon via the other sealing tube portion. In this sealing tube portion, there were the same sealing part arrangement and the frit. The frit was heated and melted using an oven under a vacuum to 1700° C. In this way, the sealing component was hermetically joined to the sealing tube portion. Thus, a discharge lamp with a distance between the electrodes of 1.2 mm, an inside diameter of the arc tube portion of 4.5 mm, a thickness of 3 mm and an inside volume of 100 mm³ was produced.

(Life Test of the Discharge Lamp)

The discharge lamp obtained in the above described manner was operated with a wall load of 1.5 W/mm³. Here, a stable light intensity was obtained. Furthermore, the duration of uninterrupted operation until the amount of radiant light dropped to 70% of the amount of radiant light during initial operation was at least 3000 hours, i.e., the duration was extremely long. Thus, a long life is achieved.

(Embodiment 2)

In this example, a discharge lamp with the arrangement shown in FIG. 2 was produced.

A material for the lamp vessel was produced in the same manner as in embodiment 1. The areas for the sealing tube portions of the material of the lamp vessel were machined by cutting into a tapered shape with an opening angle of 40° in the state of the temporarily sintered body. Furthermore, fine titanium oxide powder was applied to the side of the sintered body which is to form the outside of the lamp vessel. In this way, the outside of the material for the lamp vessel after sinter treatment was provided with a UV absorption film of titanium oxide which is deposited securely on the surface of the arc tube portion.

On the other hand, sealing components were produced in the same manner as in embodiment 1. Here, the areas of the sealing components which are to form the head parts are formed in a tapered shape with the same opening angle as the sealing tube portions by the casting mold being provided with a tapered area.

The two sealing tube portions of the lamp vessel were provided with outlet tubes of fused silica glass tubes. Here, one of the outlet tubes was hermetically sealed, the other sealing tube portion was provided with the sealing part arrangement, the two being located tightly adjoining one another by tapering with high precision, were evacuated through the outlet tube, the tightly adjoining surfaces intensively heated by means of a hydrogen-oxygen torch, and in this way, the sealing tube portion and the sealing component underwent melt joining.

Next, the filler substances were added from the other sealing tube portion in the same way as in embodiment 1, the sealing tube portion and the sealing part arrangement joined to one another in the same way as described above, afterwards the outlet tube removed and a discharge lamp produced.

In this discharge lamp as well, an advantageous light radiation characteristic was obtained. Furthermore, it was confirmed that long life with uninterrupted burning of at least 3000 hours is obtained.

(Embodiment 3)

In this example, a filament lamp with the arrangement shown in FIG. 3 was produced.

In this example, a bromine-containing filament lamp was produced in the manner described below:

To obtain a pulverized compacted body, raw powder was used in which the same silica glass powder as in embodiment 1 contained aluminum oxide with an average grain size of 0.8 microns with a volumetric proportion of 8%. Otherwise, the same method was used as described for embodiment 1 and the material for the lamp vessel produced.

This filament lamp has a lamp vessel with extremely high dimensional accuracy. This yields an advantageous light radiation characteristic. Furthermore, it was confirmed that long life with uninterrupted burning of at least 4000 hours is obtained.

Action of the Invention

As was described above, in accordance with the invention, the bulb portion and the sealing tube portions connected thereto are formed from a compacted body of sintered fused silica glass, the sealing components of a functional gradient material joined to these sealing tube portions, and a lamp vessel produced. By this measure, an bulb portion and sealing tube portions can be obtained with shapes having high dimensional accuracy, and the emission part, such as the discharge electrodes, the filament coils and the like, can be arranged with high positioning accuracy in the bulb portion. Therefore, a lamp can be devised which reliably has the expected life.

Furthermore, in this lamp, the formation of fine particles of silicon dioxide is prevented. Therefore an advantageous light radiation characteristic and long life can be obtained.

What we claim is:

1. Lamp comprising a lamp vessel with an bulb portion and sealing tube portions on opposite ends of the bulb portion, the bulb portion containing an emission part having one of discharge electrodes and a filament coil; wherein the bulb portion and sealing tube portions are formed of a compacted body of sintered silica glass; wherein sealing components are provided to which the emission part is joined, each of the sealing components being hermetically connected to a respective one of the sealing tube portions; wherein the sealing components are made of a functional gradient material which is made of silicon dioxide at a first end of each component and contains an electrically conductive inorganic material component as the main constituent of the functional gradient material at a second end of each component, the concentration of the electrically conductive inorganic material component decreasing gradually in a direction from the second end of each component.

2. Lamp as claimed in claim 1, wherein the sealing components are pushed into the sealing tube portions.

3. Lamp as claimed in claim 1, wherein the compacted body of sintered silica glass contains an aluminum oxide component in a volumetric percentage of from 1 to 10%.

4. Lamp as claimed in claim 1, wherein the compacted body of sintered silica glass contains at most 500 ppm of at least one oxide selected from the group consisting of TiO₂, CeO₂, Nd₂O₃or Fe₂O₃.

5. Lamp as claimed in claim 1, wherein the electrically conductive inorganic material is molybdenum.

6. Lamp as claimed in claim 1, wherein the first end of the sealing components is directed toward the bulb portion.

7. Lamp as claimed in claim 1, wherein each sealing tube portion of the lamp vessel and a side area of an end of the respective sealing component are interconnected by a frit material having a softening point which is lower than the softening point of the sealing tube portion and of the softening point of the side area of said end of the respective sealing component.

8. Lamp as claimed in claim 2, wherein each each sealing tube portion of the lamp vessel and a side area of an end of the respective sealing component are interconnected by a frit material having a softening point which is lower than the softening point of the sealing tube portion and of the softening point of the side area of said end of the respective sealing component.

9. Lamp as claimed in claim 1, wherein each sealing tube portion and a side area of an end of the respective sealing component are arranged tightly adjoining one another and are interconnected by adjoining areas thereof having been heated and melted.

10. Lamp as claimed in claim 2, wherein an inner peripheral surface of each sealing tube portion has a shape which opens and increases in internal diameter in a direction toward an outer end thereof; and wherein an outer peripheral surface of a side area of an end of the sealing component which has been pushed into the sealing tube has a tapering shape which matches the inner peripheral surface of the respective sealing tube portion.

11. Lamp as claimed in claim 1, wherein at least one of an inside and an outside surface of the bulb portion is provided with an UV absorption film.

12. Lamp as claimed in claim 1, wherein at least one of an inside and an outside surface of the bulb portion is provided with an IR reflection film.
